(19) United States
(12) Patent Application Publication
(10) Pub. No.: US 2005/0240650 A1
(43) Pub. Date: Oct. 27, 2005

(54) Service enablement via on demand resources

(75) Inventors: Eric Lawrence Barsness, Pine Island, MN (US); John Matthew Santosuosso, Rochester, MN (US)

Correspondence Address: IBM CORPORATION;ROCHESTER IP LAW DEPT. 917, 3605 HIGHWAY 52 NORTH, ROCHESTER, MN, 55901-7829, US

(73) Assignee: INTERNATIONAL BUSINESS MACHINES CORPORATION, ARMONK, NY (US)

(21) Appl. No.: 10/829,622

(22) Filed: Apr. 22, 2004

(51) Int. Cl. G06F 15/16

(52) U.S. Cl. 709/200

(57) ABSTRACT

A method, apparatus, system, and signal-bearing medium that in an embodiment determine whether a task is allowed to use a service-enabled resource, wherein the service-enabled resource is disabled until a fee is paid. If the task is allowed to use the service-enabled resource, then the service-enabled resource is allocated to the task. If the task is not allowed to use the service-enabled resource, then a non-service enabled resource is allocated to the task.

### FIELD

An embodiment of the invention generally relates to computers. In particular, an embodiment of the invention generally relates to services enablement using processor on demand resources.

### BACKGROUND

The development of the EDVAC computer system of 1948 is often cited as the beginning of the computer era. Since that time, computer systems have evolved into extremely sophisticated devices, and computer systems may be found in many different settings. Computer systems typically include a combination of hardware, such as semiconductors and circuit boards, and software, also known as computer programs. Computer technology continues to advance at a rapid pace, with significant developments being made in both software and in the underlying hardware upon which the software executes. One significant advance in computer technology is the development of parallel processing, i.e., the performance of multiple tasks in parallel.

A number of computer software and hardware technologies have been developed to facilitate increased parallel processing. From a hardware standpoint, computers increasingly rely on multiple microprocessors to provide increased workload capacity. Furthermore, some microprocessors have been developed that support the ability to execute multiple threads in parallel, effectively providing many of the same performance gains attainable through the use of multiple microprocessors. From a software standpoint, multithreaded operating systems and kernels have been developed, which permit computer programs to concurrently execute in multiple threads so that multiple tasks can essentially be performed at the same time.

In addition, some computers implement the concept of logical partitioning, where a single physical computer is permitted to operate essentially like multiple and independent virtual computers, referred to as logical partitions, with the various resources in the physical computer (e.g., processors, memory, and input/output devices) allocated among the various logical partitions. Each logical partition executes a separate operating system, and from the perspective of users and of the software applications executing on the logical partition, operates as a fully independent computer.

In order to support logical partitions and to provide higher performance, many new computers are being shipped with multiple processors. Some new computers are even shipped with more processors than the customer actually ordered, which are initially disabled and not used. These spare processors allow for a feature known as processor on demand (POD), where the customer has the opportunity to pay a one-time fee to permanently upgrade to use the spare processor or a periodic fee to temporarily use the spare processor. Since the spare processors are already installed, the computer does not need to be physically upgraded in order to enjoy increased performance, so no downtime is required, which minimizes the impact of the upgrade on the customer's current operations. As the field of processor on demand evolves, more computers exist with processors that are not currently being used.

Customers may have the need for the services of additional software, but they may be reluctant to load and use the additional software on their computer because of the potential performance impact to existing operations. Thus, they might not take advantage of services that might be helpful to them because of performance concerns, despite that their computers have a spare processor.

Without a better way to manage additional software and spare processors, customers will not be able to take full advantage of helpful services and processors. Although the aforementioned problems have been described in the context of extra, unutilized processors, they can exist for any unutilized resource, such as memory, I/O (Input/Output) cards, or network bandwidth.

### SUMMARY

In embodiment, a method is provided that comprises determining whether a task is allowed to use a service-enabled resource, wherein the service-enabled resource is disabled until a fee is paid; and if the determining is true, allocating the service-enabled resource to the task.

In another embodiment, an apparatus is provided that comprises means for determining whether a task is allowed to use a service-enabled resource, wherein the service-enabled resource is disabled until a fee is paid; means for allocating the service-enabled resource to the task if the determining is true; and means for allocating a non-service enabled resource to the task if the determining is false.

In another embodiment, a signal-bearing medium encoded with instructions is provided, wherein the instructions when executed comprise: determining whether a task is allowed to use a service-enabled resource, wherein the service-enabled resource is disabled until a fee is paid; allocating the service-enabled resource to the task if the determining is true; and allocating a non-service enabled resource to the task if the determining is false.

In another embodiment, a computer system having a plurality of logical partitions is provided, the computer system comprising: a plurality of processors; a spare processor, wherein use of the spare processor is disabled until a fee is paid; and memory encoded with instructions, wherein the instructions when executed on one of the plurality of processors comprise: determining whether a task is allowed to use the spare processor, dispatching the task to the spare processor if the determining is true, and dispatching the task to one of the plurality of processors if the determining is false.

In another embodiment, a method for configuring a computer is provided, wherein the method comprises: configuring the computer to determine whether a task is allowed to use a service-enabled resource, wherein the service-enabled resource is disabled until a fee is paid; and configuring the computer to allocate the service-enabled resource to the task if the determining is true.

### BRIEF DESCRIPTION OF THE DRAWING

FIG. 1 depicts a block diagram of an example system for implementing an embodiment of the invention.

FIG. 2 depicts a block diagram for an example services enablement data structure, according to an embodiment of the invention.

FIG. 3 depicts a flowchart of example processing for a hypervisor, according to an embodiment of the invention.

### DETAILED DESCRIPTION

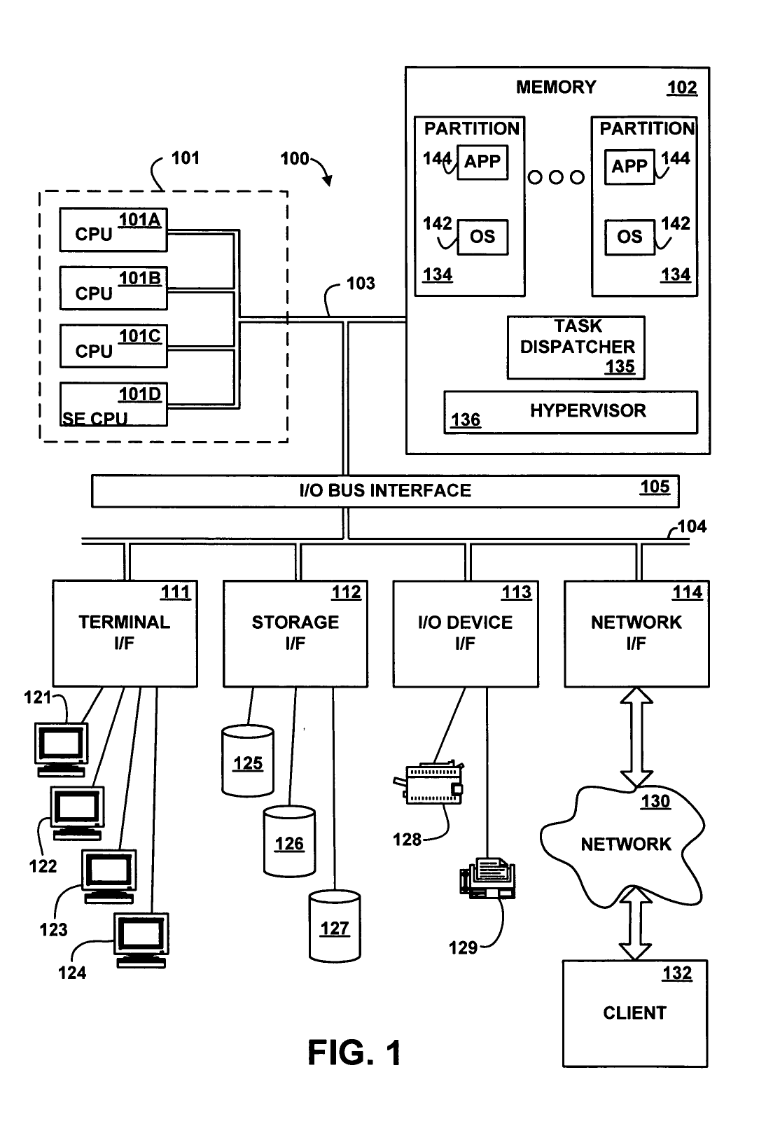

Referring to the Drawing, wherein like numbers denote like parts throughout the several views, FIG. 1 depicts a high-level block diagram representation of a computer system 100 connected via a network 130 to a client 132, according to an embodiment of the present invention. The major components of the computer system 100 include one or more processors 101, a main memory 102, a terminal interface 111, a storage interface 112, an I/O (Input/Output) device interface 113, and communications/network interfaces 114, all of which are coupled for inter-component communication via a memory bus 103, an I/O bus 104, and an I/O bus interface unit 105.

The computer system 100 contains one or more general-purpose programmable central processing units (CPUs) 101A, 101B, 101C, and 101D, herein generically referred to as processor 101. In an embodiment, the computer system 100 contains multiple processors typical of a relatively large system; however, in another embodiment the computer system 100 may alternatively be a single CPU system. Each processor 101 executes instructions stored in the main memory 102 and may include one or more levels of on-board cache.

Each processor 101 may be implemented as a single threaded processor, or as a multithreaded processor. For the most part, each hardware thread in a multithreaded processor is treated like an independent processor by the software resident in the computer 100. In this regard, for the purposes of this disclosure, a single threaded processor will be considered to incorporate a single hardware thread, i.e., a single independent unit of execution. It will be appreciated, however, that software-based multithreading or multitasking may be used in connection with both single threaded and multithreaded processors to further support the parallel performance of multiple tasks in the computer 100.

In addition, one or more of processors 101 may be implemented as a service processor, which is used to run specialized firmware code to manage system initial program loads (IPLs) and to monitor, diagnose and configure system hardware. Generally, the computer 100 will include one service processor and multiple system processors, which are used to execute the operating systems and applications resident in the computer 100, although other embodiments of the invention are not limited to this particular implementation. In some embodiments, a service processor may be coupled to the various other hardware components in the computer 100 in a manner other than through the bus 103.

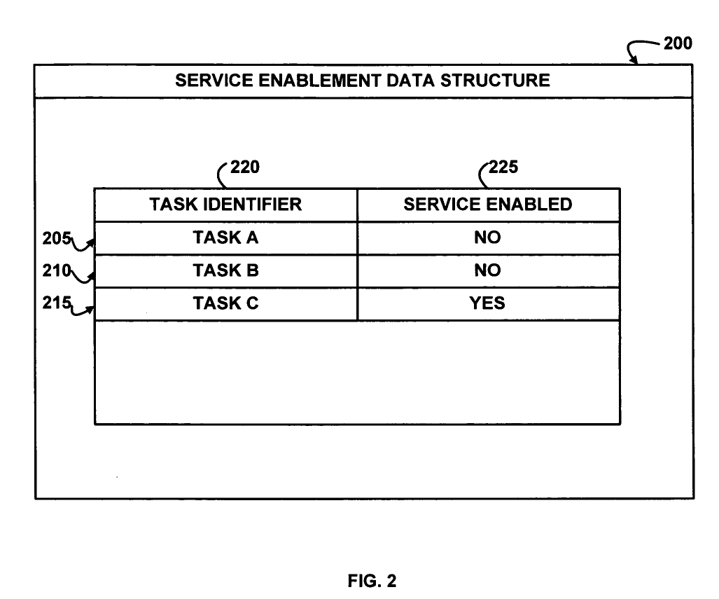

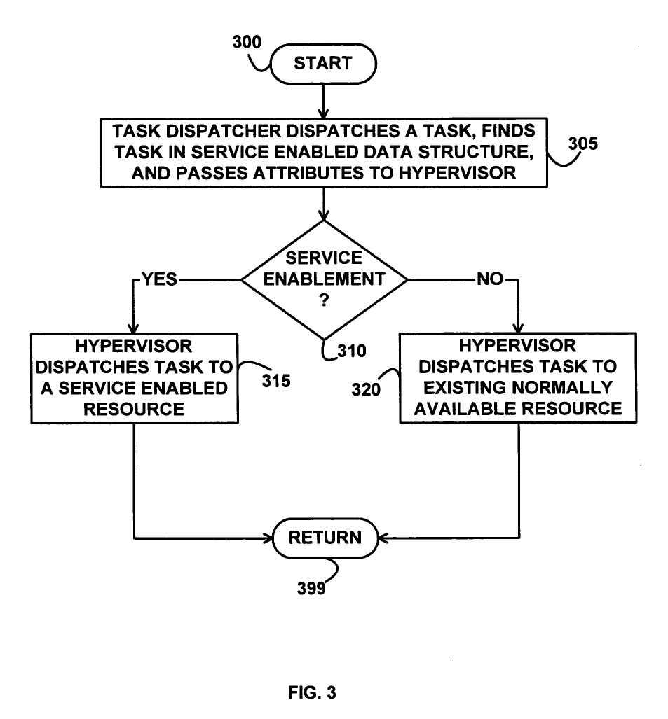

One of the CPUs 101D is designated as a service-enabled resource, meaning it is a spare processor that is not used for normal operations of the computer system 100 and is disabled for normal use until a one-time or periodic fee is paid. The CPU 101D belongs to a class of service-enabled resources, which are only used by specially-designated tasks, as further described below with reference to FIGS. 2 and 3. Although FIG. 1 illustrates only one CPU 101D as a service-enabled processor, in other embodiments any number of processors may belong to the class of service-enabled resources. Although FIG. 1 illustrates a processor as being a service-enabled resource, in other embodiments a service-enabled resource may be a portion of memory, a storage device, a portion of a storage device, a disk arm, an I/O card, network bandwidth, or any other appropriate allocatable resource. In another embodiment, partial processors called processing units may be service enabled, with a processor including any number of processing units.

The main memory 102 is a random-access semiconductor memory for storing data and programs. The main memory 102 is conceptually a single monolithic entity, but in other embodiments the main memory 102 is a more complex arrangement, such as a hierarchy of caches and other memory devices. E.g., memory may exist in multiple levels of caches, and these caches may be further divided by function, so that one cache holds instructions while another holds non-instruction data, which is used by the processor 101. Memory may further be distributed and associated with different CPUs or sets of CPUs, as is known in any of various so-called non-uniform memory access (NUMA) computer architectures.

The memory 102 is illustrated as containing the primary software components and resources utilized in implementing a logically partitioned computing environment on the computer 100, including a plurality of logical partitions 134 managed by a task dispatcher 135 and a partition manager or hypervisor 136. Any number of logical partitions 134 may be supported as is well known in the art, and the number of the logical partitions 134 resident at any time in the computer 100 may change dynamically as partitions are added or removed from the computer 100.

Although the hypervisor 136 is illustrated as being within the memory 102, in other embodiments, all or a portion of the hypervisor 102 may be implemented in firmware or hardware. The hypervisor 136 may perform both low-level partition management functions, such as page table management and may also perform higher-level partition management functions, such as creating and deleting partitions, concurrent I/O maintenance, allocating processors, memory and other hardware resources to various the partitions 134.

Each logical partition 134 is typically statically and/or dynamically allocated a portion of the available resources in computer 100. For example, each logical partition 134 may be allocated one or more of the processors 101 and/or one or more hardware threads, as well as a portion of the available memory space. The logical partitions 134 can share specific hardware resources such as the processors 101, such that a given processor 101 is utilized by more than one logical partition. In the alternative, hardware resources can be allocated to only one logical partition 134 at a time.

Additional resources, e.g., mass storage, backup storage, user input, network connections, and the I/O adapters therefor, are typically allocated to one or more of the logical partitions 134. Resources may be allocated in a number of manners, e.g., on a bus-by-bus basis, or on a resource-by-resource basis, with multiple logical partitions sharing resources on the same bus. Some resources may even be allocated to multiple logical partitions at a time.

Each of the logical partitions 134 utilizes an operating system 142, which controls the primary operations of the logical partition 134 in the same manner as the operating system of a non-partitioned computer. For example, each operating system 142 may be implemented using the OS/400 operating system available from International Business Machines Corporation, but in other embodiments the operating system 142 may be Linux, AIX, or any appropriate operating system. Also, some or all of the operating systems 142 may be the same or different from each other.

Each of the logical partition 134 executes in a separate, or independent, memory space, and thus each logical partition acts much the same as an independent, non-partitioned computer from the perspective of each application 144 that executes in each such logical partition. As such, user applications typically do not require any special configuration for use in a partitioned environment. Given the nature of logical partitions 134 as separate virtual computers, it may be desirable to support inter-partition communication to permit the logical partitions to communicate with one another as if the logical partitions were on separate physical machines. As such, in some implementations it may be desirable to support an unillustrated virtual local area network (LAN) adapter associated with the hypervisor 136 to permit the logical partitions 134 to communicate with one another via a networking protocol such as the Ethernet protocol. In another embodiment, the virtual network adapter may bridge to a physical adapter, such as the network interface adapter 114. Other manners of supporting communication between partitions may also be supported consistent with embodiments of the invention.

Although the partitions 134, the task dispatcher 135, and the hypervisor 136 are illustrated as being contained within the memory 102 in the computer system 100, in other embodiments some or all of them may be on different computer systems, e.g., the client 132, and may be accessed remotely, e.g., via the network 130. Further, the computer system 100 may use virtual addressing mechanisms that allow the programs of the computer system 100 to behave as if they only have access to a large, single storage entity instead of access to multiple, smaller storage entities. Thus, while the partitions 134, the task dispatcher 135, and the hypervisor 136 are illustrated as residing in the memory 102, these elements are not necessarily all completely contained in the same storage device at the same time.

The task dispatcher 135 dispatches tasks, such as portions of the operating system 142 and the application 144, for execution on various of the processors 101. The functions of the task dispatcher 135 are further described below with reference to FIG. 3. Although the task dispatcher 135 and the hypervisor 136 are illustrated as being separate entities, in another embodiment they may be implemented via the same entity.

In an embodiment, the hypervisor 136 includes instructions capable of executing on the processor 101 or statements capable of being interpreted by instructions executing on the processor 101 to perform the functions as further described below with reference to FIG. 3. In another embodiment, the hypervisor 136 may be implemented in microcode or firmware. In another embodiment, the hypervisor 136 may be implemented in hardware via logic gates and/or other appropriate hardware techniques.

The memory bus 103 provides a data communication path for transferring data among the processors 101, the main memory 102, and the I/O bus interface unit 105. The I/O bus interface unit 105 is further coupled to the system I/O bus 104 for transferring data to and from the various I/O units. The I/O bus interface unit 105 communicates with multiple I/O interface units 111, 112, 113, and 114, which are also known as I/O processors (IOPs) or I/O adapters (IOAs), through the system I/O bus 104. The system I/O bus 104 may be, e.g., an industry standard PCI (Peripheral Component Interconnect) bus, or any other appropriate bus technology. The I/O interface units support communication with a variety of storage and I/O devices. For example, the terminal interface unit 111 supports the attachment of one or more user terminals 121, 122, 123, and 124. The storage interface unit 112 supports the attachment of one or more direct access storage devices (DASD) 125, 126, and 127 (which are typically rotating magnetic disk drive storage devices, although they could alternatively be other devices, including arrays of disk drives configured to appear as a single large storage device to a host). The contents of the DASD 125, 126, and 127 may be selectively loaded from and stored to the memory 102 as needed.

The I/O and other device interface 113 provides an interface to any of various other input/output devices or devices of other types. Two such devices, the printer 128 and the fax machine 129, are shown in the exemplary embodiment of FIG. 1, but in other embodiment many other such devices may exist, which may be of differing types. The network interface 114 provides one or more communications paths from the computer system 100 to other digital devices and computer systems; such paths may include, e.g., one or more networks 130.

Although the memory bus 103 is shown in FIG. 1 as a relatively simple, single bus structure providing a direct communication path among the processors 101, the main memory 102, and the I/O bus interface 105, in other embodiments the memory bus 103 may comprise multiple different buses or communication paths, which may be arranged in any of various forms, such as point-to-point links in hierarchical, star or web configurations, multiple hierarchical buses, or parallel and redundant paths. Furthermore, while the I/O bus interface 105 and the I/O bus 104 are shown as single respective units, the computer system 100 may in fact contain multiple I/O bus interface units 105 and/or multiple I/O buses 104. While multiple I/O interface units are shown, which separate the system I/O bus 104 from various communications paths running to the various I/O devices, in other embodiments some or all of the I/O devices are connected directly to one or more system I/O buses.

The network 130 may be any suitable network or combination of networks and may support any appropriate protocol suitable for communication of data and/or code to/from the computer system 100. In various embodiments, the network 130 may represent a storage device or a combination of storage devices, either connected directly or indirectly to the computer system 100. In an embodiment, the network 130 may support Infiniband. In another embodiment, the network 130 may support wireless communications. In another embodiment, the network 130 may support hard-wired communications, such as a telephone line or cable. In another embodiment, the network 130 may support the Ethernet IEEE (Institute of Electrical and Electronics Engineers) 802.3x specification. In another embodiment, the network 130 may be the Internet and may support IP (Internet Protocol). In another embodiment, the network 130 may be a local area network (LAN) or a wide area network (WAN). In another embodiment, the network 130 may be a hotspot service provider network. In another embodiment, the network 130 may be an intranet. In another embodiment, the network 130 may be a GPRS (General Packet Radio Service) network. In another embodiment, the network 130 may be a FRS (Family Radio Service) network. In another embodiment, the network 130 may be any appropriate cellular data network or cell-based radio network technology. In another embodiment, the network 130 may be an IEEE 802.11B wireless network. In still another embodiment, the network 130 may be any suitable network or combination of networks. Although one network 130 is shown, in other embodiments any number of networks (of the same or different types) may be present.

The computer system 100 depicted in FIG. 1 has multiple attached terminals 121, 122, 123, and 124, such as might be typical of a multi-user or mainframe computer system. Typically, in such a case the actual number of attached devices is greater than those shown in FIG. 1, although the present invention is not limited to systems of any particular size. The computer system 100 may alternatively be a single-user system, typically containing only a single user display and keyboard input, or might be a server or similar device which has little or no direct user interface, but receives requests from other computer systems (clients). In other embodiments, the computer system 100 may be implemented as a personal computer, portable computer, laptop or notebook computer, PDA (Personal Digital Assistant), tablet computer, pocket computer, telephone, pager, automobile, teleconferencing system, appliance, or any other appropriate type of electronic device.

It should be understood that FIG. 1 is intended to depict the representative major components of the computer system 100 at a high level, that individual components may have greater complexity that represented in FIG. 1, that components other than or in addition to those shown in FIG. 1 may be present, and that the number, type, and configuration of such components may vary. Several particular examples of such additional complexity or additional variations are disclosed herein; it being understood that these are by way of example only and are not necessarily the only such variations.

The various software components illustrated in FIG. 1 and implementing various embodiments of the invention may be implemented in a number of manners, including using various computer software applications, routines, components, programs, objects, modules, data structures, etc., referred to hereinafter as “computer programs,” or simply “programs.” The computer programs typically comprise one or more instructions that are resident at various times in various memory and storage devices in the computer system 100, and that, when read and executed by one or more processors 101 in the computer system 100, cause the computer system 100 to perform the steps necessary to execute steps or elements embodying the various aspects of an embodiment of the invention.

Moreover, while embodiments of the invention have and hereinafter will be described in the context of fully functioning computer systems, the various embodiments of the invention are capable of being distributed as a program product in a variety of forms, and the invention applies equally regardless of the particular type of signal-bearing medium used to actually carry out the distribution. The programs defining the functions of this embodiment may be delivered to the computer system 100 via a variety of signal-bearing media, which include, but are not limited to:
(1) information permanently stored on a non-rewriteable storage medium, e.g., a read-only memory device attached to or within a computer system, such as a CD-ROM readable by a CD-ROM drive;
(2) alterable information stored on a rewriteable storage medium, e.g., a hard disk drive (e.g., DASD 125, 126, or 127) or diskette; or
(3) information conveyed to the computer system 100 by a communications medium, such as through a computer or a telephone network, e.g., the network 130, including wireless communications.

Such signal-bearing media, when carrying machine-readable instructions that direct the functions of the present invention, represent embodiments of the present invention.

In addition, various programs described hereinafter may be identified based upon the application for which they are implemented in a specific embodiment of the invention. But, any particular program nomenclature that follows is used merely for convenience, and thus embodiments of the invention should not be limited to use solely in any specific application identified and/or implied by such nomenclature.

The exemplary environments illustrated in FIG. 1 are not intended to limit the present invention. Indeed, other alternative hardware and/or software environments may be used without departing from the scope of the invention.

FIG. 2 depicts a block diagram for an example services enablement data structure 200, according to an embodiment of the invention. The services enablement data structure 200 may be associated with the operating system 142, the partition 134, or the task dispatcher 135. The services enablement data structure 200 includes entries 205, 210, and 215, but in other embodiments any number of entries with any appropriate data may be present. Each entry 205, 210, and 215 includes a task identifier field 220 and a service-enabled field 225. The task identifier field 220 identifies a task that may need a resource of the computer system 100. A resource of the computer system 100 may be the processor 101, the memory 102, the I/O interfaces 111, 112, 113, or 114, bandwidth of the network 130, or any other allocatable resource. A task may be the application 144, the operating system 142, or any portion thereof. The service-enabled field 225 indicates whether the task identified in the respective task identifier field 220 is allowed to use a service-enabled resource. A service-enabled resource is a resource of the computer system 100 that may only be allocated to a task authorized to use the resource by the service-enabled field 225 in the service enablement data structure 200.

The enabling/setting of the service-enabled field 225 is a restricted activity that may be controlled by the provider of the computer system 100. Using the service-enabled field 225, the provider may deliver software and services that do not adversely affect the performance of the computer system 100. The provider may also enter into agreements that allow third parties to modify the service-enabled field 225. Examples of tasks that may be service-enabled are a performance monitoring task, a diagnostic task, a task that checks for proper level of the operating system 142, or any other appropriate task. In an embodiment, a one time or periodic fee must be paid in order to use the service-enabled resource. In other embodiments, no additional fee is necessary.

FIG. 3 depicts a flowchart of example processing for the task dispatcher 135 and the hypervisor 136, according to an embodiment of the invention. Control begins at block 300. Control then continues to block 305 where the task dispatcher 135 prepares to dispatch a task, finds the entry in the service enabled data structure 200 that is associated with the task via the task identifier field 220, and passes the attributes of the task to the hypervisor 136, including the contents of the service enabled field 225.

Control then continues to block 310 where the hypervisor 136 examines the contents of the service enabled field 225 to determine whether service enablement is allowed. If the determination at block 310 is true, then control continues to block 315 where the hypervisor 136 dispatches the task to the service-enabled resource or allocates the service-enabled resource to the task. If the service-enabled resource is a processor, such as the service-enabled processor 101D, then the task executes on the processor. If the partition 134 associated with the task is using dedicated processors, then the service-enabled processor 101D is dedicated to the partition. If the computer system 100 is using a shared processor pool, then the service-enabled processor 101D is added to the pool, but is used only by the service-enabled tasks, i.e., the tasks in the service enablement data structure 200 with the service-enabled indicator 225 set to yes. If the service-enabled resource is memory, an I/O card, network bandwidth, or other resource, then the resource is allocated to the task.

Control then continues to block 399 where the logic of FIG. 3 returns.

If the determination at block 310 is false, then control continues to block 320 where the hypervisor 136 dispatches the task to an existing normally-available resource for which no additional fee is required for use. Control then continues to block 399 where the logic of FIG. 3 returns.

In the previous detailed description of exemplary embodiments of the invention, reference was made to the accompanying drawings (where like numbers represent like elements), which form a part hereof, and in which is shown by way of illustration specific exemplary embodiments in which the invention may be practiced. These embodiments were described in sufficient detail to enable those skilled in the art to practice the invention, but other embodiments may be utilized and logical, mechanical, electrical, and other changes may be made without departing from the scope of the present invention. Different instances of the word “embodiment” as used within this specification do not necessarily refer to the same embodiment, but they may. The previous detailed description is, therefore, not to be taken in a limiting sense, and the scope of the present invention is defined only by the appended claims.

In the previous description, numerous specific details were set forth to provide a thorough understanding of the invention. But, the invention may be practiced without these specific details. In other instances, well-known circuits, structures, and techniques have not been shown in detail in order not to obscure the invention.

1. A method comprising:
determining whether a task is allowed to use a service-enabled resource, wherein the service-enabled resource is disabled until a fee is paid; and
if the determining is true, allocating the service-enabled resource to the task.

2. The method of claim 1, wherein the service-enabled resource comprises a processor in a multi-processor system and the allocating further comprises dispatching the task to the processor.

3. The method of claim 2, further comprising:
adding the processor to a shared pool associated with a partition to which the task belongs.

4. The method of claim 1, further comprising:
if the determining is false, allocating a non-service enabled resource to the task.

5. An apparatus comprising:
means for determining whether a task is allowed to use a service-enabled resource, wherein the service-enabled resource is disabled until a fee is paid;
means for allocating the service-enabled resource to the task if the determining is true; and
means for allocating a non-service enabled resource to the task if the determining is false.

6. The apparatus of claim 5, wherein the service-enabled resource comprises a processor in a multi-processor system and the means for allocating the service-enabled resource further comprises means for dispatching the task to the processor.

7. The apparatus of claim 6, further comprising:
means for adding the processor to a shared pool associated with a partition to which the task belongs if the determining is true.

8. The apparatus of claim 6, further comprising:
means for dedicating the processor to a partition to which the task belongs if the determining is true.

9. A signal-bearing medium encoded with instructions, wherein the instructions when executed comprise:
determining whether a task is allowed to use a service-enabled resource, wherein the service-enabled resource is disabled until a fee is paid;
allocating the service-enabled resource to the task if the determining is true; and
allocating a non-service enabled resource to the task if the determining is false.

10. The signal-bearing medium of claim 9, wherein the service-enabled resource comprises memory.

11. The signal-bearing medium of claim 9, wherein the service-enabled resource comprises an I/O card.

12. The signal-bearing medium of claim 9, wherein the service-enabled resource comprises network bandwidth.

13. A computer system having a plurality of logical partitions, the computer system comprising:
a plurality of processors;
a spare processor, wherein use of the spare processor is disabled until a fee is paid; and
memory encoded with instructions, wherein the instructions when executed on one of the plurality of processors comprise:
determining whether a task is allowed to use the spare processor,
dispatching the task to the spare processor if the determining is true, and
dispatching the task to one of the plurality of processors if the determining is false.

14. The computer system of claim 13, wherein the instructions further comprise:
adding the spare processor to a shared pool associated with a partition to which the task belongs if the determining is true.

15. The computer system of claim 13, wherein the instructions further comprise:
dedicating the spare processor to a partition to which the task belongs if the determining is true.

16. The computer system of claim 13, wherein the determining further comprises:
checking a data structure comprising task identifiers and service-enabled indicators.

17. A method for configuring a computer, wherein the method comprises:
configuring the computer to determine whether a task is allowed to use a service-enabled resource, wherein the service-enabled resource is disabled until a fee is paid; and
configuring the computer to allocate the service-enabled resource to the task if the determining is true.

18. The method of claim 17, wherein the service-enabled resource comprises a processor in a multi-processor system and the configuring the computer to allocate further comprises dispatching the task to the processor.

19. The method of claim 18, further comprising:
configuring the computer to add the processor to a shared pool associated with a partition to which the task belongs.

20. The method of claim 17, further comprising:
configuring the computer to allocate a non-service enabled resource to the task if the determining is false.
